(19) United States
(12) Patent Application Publication
(10) Pub. No.: US 2011/0162952 A1
(43) Pub. Date: Jul. 7, 2011

(54) Salt water desalination using energy from gasification process

(75) Inventors: John A. Conchieri, Greenfield Center, NY (US); Delome D. Fair, Houston, TX (US)

(73) Assignee: General Electric Company, Schenectady, NY (US)

(21) Appl. No.: 12/654,883

(22) Filed: Jan. 7, 2010

(51) Int. Cl. C02F 1/06; C02F 1/04; B01D 5/00

(52) U.S. Cl. 203/11; 202/185.1; 202/173

(57) ABSTRACT

System and process for producing no-salt water by desalination of salt water, by heating salt water directly with heated synthetic gas produced in a gasification reaction or by using steam produced using heated synthetic gas, to evaporate the salt water and produce no-salt water.

The present invention relates to salt water desalination using multi-stage flash or multi-effect distillation in conjunction with a gasification process which produces syngas at elevated temperature and which is utilized to generate a fresh water supply.

### BACKGROUND OF THE INVENTION

Salt water desalination using multi-stage flash (MSF) or multi-effect distillation (MED) is a process that receives heat from a low pressure, high quality steam energy source. In this process, low pressure steam is generated with common boiler technology (see U.S. Pat. Nos. 4,338,199 and 5,441,548).

It is known to use other forms of energy for desalination. For example, U.S. Pat. No. 5,421,962 utilizes solar energy for desalination processes.

Energy inefficiencies arise when employing low pressure steam for driving a desalination plant. A need exists, therefore, to provide an improved process for carrying out a desalination process with improved energy efficiency. The present invention seeks to fill that need.

### SUMMARY OF THE INVENTION

It has now been discovered, according to the present invention, that it is possible to transfer heat from a raw synthetic gas either directly, or indirectly from a low quality fluid such as steam produced by heat transfer from raw synthetic gas to water, to salt water to generate no-salt fresh water containing no or essentially no salt, while cooling the synthetic gas for subsequent gas clean-up processes.

In one aspect, the present invention provides a process for producing no-salt water by desalination of salt water, by heating salt water directly with synthetic gas produced in a gasification reaction to evaporate the salt water and produce water containing no salt or essentially no salt.

The term “no-salt” water for purposes of the present invention means water from which at least 99 wt % of salt originally present has been removed, more typically water from which 99-100 wt % of salt originally present has been removed.

In an alternative embodiment, saturated steam produced using heat from raw synthetic gas produced in a gasification reaction is employed to evaporate salt water and produce fresh no-salt water.

In a further embodiment of the invention, there is provided a first system for producing no-salt water by desalination of salt water, comprising a source of salt water, a source of synthetic gas, a heating chamber connected to the source of salt water and to the source of synthetic gas, the heating chamber having a synthetic gas inlet and a synthetic gas outlet and a pathway for the salt water to pass through the heating chamber. The system further includes at least one flash tank operable under reduced pressure connected to the pathway for receiving water vapor generated in the pathway, and a collector for collecting condensate containing no or essentially no salt. In operation, salt water from the salt water source is introduced into the pathway of the heating chamber and hot synthetic gas from the synthetic gas source is introduced into the synthetic gas inlet of the heating chamber. Heat from the hot synthetic gas is transferred to the salt water to produce water vapor which is condensed in the distillation chamber to produce no-salt water, which is collected.

In an alternative embodiment of the first system, there is additionally provided a low pressure steam generator having a synthetic gas inlet and a synthetic gas outlet. Hot synthetic gas is fed into the steam generator through the synthetic gas inlet and low pressure steam is generated which is fed to a steam inlet in the heating chamber, whereby heat is transferred to salt water passing though the pathway disposed within the heating chamber to form water vapor which is condensed and collected as no-salt water. The heating chamber in this embodiment is provided with a steam condensate outlet through which steam condensate formed as a result of condensation of the steam from the steam generator is drained. This system further comprises a knock-out drum though which synthetic gas exiting the steam generator passes to allow moisture in the synthetic gas to condense and be separated from the synthetic gas prior to downstream clean-up of the synthetic gas.

In another embodiment of the invention, there is provided a second system for producing water by desalination of salt water, comprising a source of salt water, a source of synthetic gas, a first evaporation chamber having a synthetic gas inlet and a synthetic gas outlet, the synthetic gas inlet being connected to a pathway, typically a metallic heat transfer coil, for hot synthetic gas to pass through the evaporator and effect heat transfer to salt water present in the evaporator to produce water vapor in the first evaporation chamber, a second evaporation chamber having a second pathway, typically a heat transfer coil, into which water vapor is received from the first evaporation chamber, whereby the water vapor in the second heat transfer coil is cooled by heat transfer with salt water contacting the exterior of the second heat transfer coil to form a no-salt water condensate, the heat transfer process forming further water vapor by evaporation, and a collector for collecting condensate containing no or essentially no salt.

In an alternative embodiment of the second system, there is additionally provided a low pressure steam generator having a synthetic gas inlet and a synthetic gas outlet. Hot synthetic gas is fed into the steam generator through the synthetic gas inlet and low pressure steam is generated which is fed to a steam inlet in the first evaporation chamber and enters the pathway, whereby heat is transferred from steam in the pathway to salt water present in the evaporation chamber to form water vapor which is condensed in the second evaporation chamber and collected as no-salt water condensate. The first evaporation chamber in this embodiment is provided with a steam condensate outlet through which steam condensate formed in the pathway as a result of condensation of the steam from the steam generator is drained. This system further comprises a knock-out drum though which synthetic gas exiting the pathway of the steam generator passes to allow moisture in the synthetic gas to condense and be separated from the synthetic gas prior to downstream clean-up of the synthetic gas.

In further embodiment of the first system, there is provided a source of salt water, a source of synthetic gas, an externally heated radiant syngas cooler connected to the synthetic gas source, an auxiliary superheater, a heating chamber connected to the source of salt water and to the source of synthetic gas, the heating chamber having a synthetic gas inlet and a synthetic gas outlet, a pathway for the salt water to pass through the heating chamber, at least one flash tank connected to the pathway for receiving water vapor generated in the pathway and a collector for collecting condensate containing no or essentially no salt. In operation, hot synthetic gas produced in the source of synthetic gas passes to the radiant syngas cooler where heat transfer occurs to produce high pressure saturated steam and cooled wet raw synthetic gas. The high pressure steam passes to the auxiliary superheater where the steam is superheated and may be used to drive auxiliary steam turbo machinery. Low pressure steam resulting from driving such auxiliary steam turbo machinery is introduced into the heating chamber together with low pressure steam produced by heat transfer using hot synthetic gas. The system otherwise operates as described above for the first system.

In further embodiment of the second system, there is provided a source of salt water, a source of synthetic gas, an externally heated radiant syngas cooler connected to the synthetic gas source, an auxiliary superheater, a first evaporator connected to the source of salt water, the evaporator having a low pressure steam inlet, a steam condensate outlet, a pathway for the steam to pass through the evaporator, a second evaporation chamber connected to the first evaporator for receiving water vapor generated as a result of heat transfer from steam passing through the pathway, and a collector for collecting condensate containing no or essentially no salt. In operation, hot synthetic gas produced in the synthetic gas source passes to the radiant syngas cooler where heat transfer occurs to produce high pressure saturated steam and cooled wet raw synthetic gas. The high pressure steam passes to the auxiliary superheater where the steam is superheated and may be used to drive auxiliary steam turbo machinery. Low pressure steam resulting from driving auxiliary steam turbo machinery is introduced into the evaporator together with low pressure steam produced by heat transfer using hot synthetic gas. The system otherwise operates as described above for the second system.

### BRIEF DESCRIPTION OF THE DRAWINGS

FIG. 1 is a schematic of an embodiment of an integrated process of the invention utilizing multiple stage flash desalination;

FIG. 2 is a schematic of an embodiment of an integrated process of the invention utilizing multiple effect distillation desalination;

FIG. 3 is a schematic of an alternative embodiment of FIG. 1 where high temperature, raw, wet syngas transfers heat to a low pressure saturated steam generator and the low pressure saturated steam is used to transfer heat energy directly into a salt water feed stream;

FIG. 4 is a schematic of an alternative embodiment of FIG. 2 where high temperature, raw, wet syngas transfers heat to a low pressure saturated steam generator and the low pressure saturated steam is used to transfer heat energy directly into a salt water feed stream;

FIG. 5 is a schematic of another embodiment of FIG. 1 where high temperature, raw, syngas is cooled by heat transfer by contact with a radiant syngas cooler, high pressure saturated steam produced by such heat transfer is superheated through an auxiliary superheater and used to drive auxiliary steam turbo machinery, and low pressure steam resulting from driving such machinery is passed to the heating chamber to transfer heat energy directly into a salt water feed stream;

FIG. 6 is a schematic of another embodiment of FIG. 2 where high temperature, raw, syngas is cooled by heat transfer by contact with a radiant syngas cooler, high pressure saturated steam produced by such heat transfer is superheated through an auxiliary superheater and used to drive auxiliary steam turbo machinery, and low pressure steam resulting from driving such machinery is passed to the evaporator to transfer heat energy directly into a salt water feed stream.

### DETAILED DESCRIPTION OF THE INVENTION

Gasification is a process that generates a substantial amount of reaction heat by converting a fuel feedstock into a raw synthetic gas. Heat within the raw synthetic gas is typically dissipated and quenched to allow for the heat to be transferred into other process streams and to bring the raw synthetic gas to a lower temperature suitable for subsequent gas cleaning processes in which undesirable components such as acids, sulfur, mercury, and other known elements that are contained within the raw synthetic gas are removed.

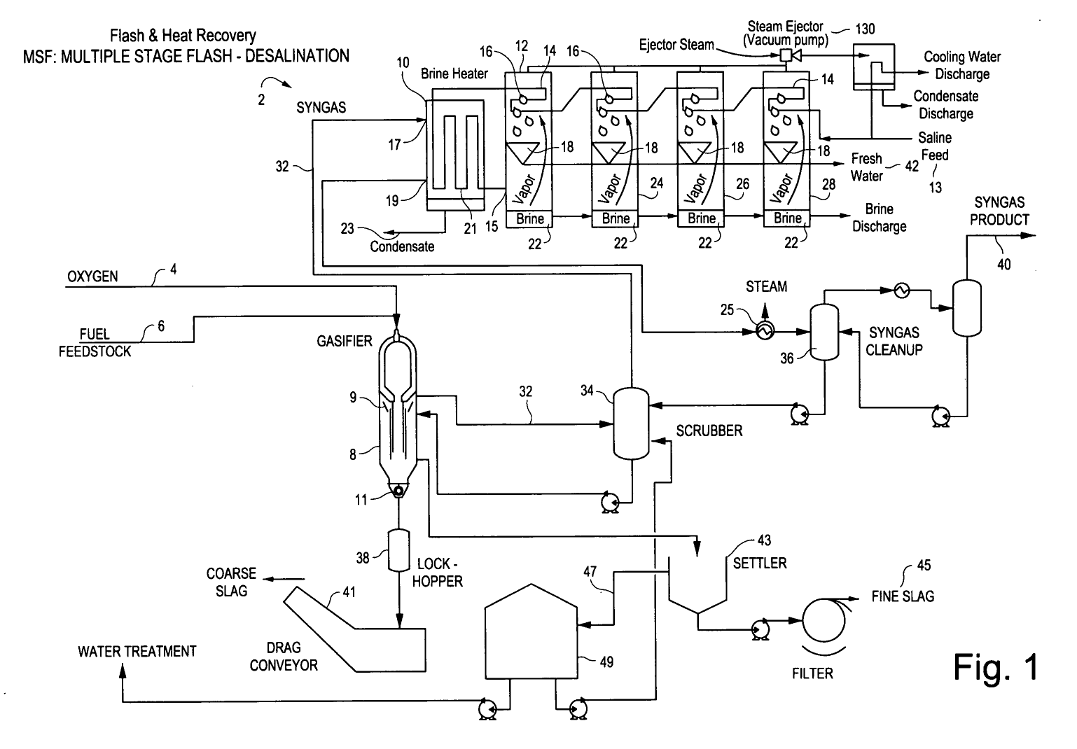

Referring to the drawings, FIG. 1 shows a first embodiment of the process of the invention utilizing a multiple stage flash desalination system 2. In this process, an oxidant (for example oxygen) 4 and a fuel feedstock 6 are injected into gasifier 8 which serves as a source of synthetic gas (syngas). The rate of oxidant injection is controlled such that the amount of oxidant in the gasifier 8 is intentionally deprived resulting in an incomplete combustion process. Only a portion of the chemical energy contained in the fuel feedstock is converted into heat energy, while the unconverted chemical energy transforms into a raw synthetic gaseous energy source.

The produced synthetic gas exiting the gasifier 8 commonly contains ash and other elements that must be removed by downstream process equipment. The gasifier 8 shown in FIG. 1 also includes a water quench 9 for initial gas cooling with a funnel-shaped slag collector 11 at the bottom. The slag collector 11 acts as both a collector and chute, in that it collects water as well as coarse and fine slag (large scale, heavy particulate matter) that falls from the gasifier reaction zone. The coarse slag slides down the chute and into the lock hopper 38 for removal. Wet scrubbing station 34 removes smaller scale, light particulate matter, such as fine ash, that is carried over by the raw syngas 32. Thus, removal of solid particulate matter occurs in both the quench chamber of the gasifier 8 and the scrubber 34, although scrubbing occurs more extensively in scrubber 34.

The reactant products of gasification are quenched in the gasifier 8 with syngas scrubber discharge water. This produces a stream of raw wet syngas which has been cooled to a temperature suitable for entry into heating chamber (brine heater) 10.

The heating chamber 10 is provided with a syngas inlet port 17, a syngas outlet port 19, and a pathway, typically a metallic heat transfer coil 21, disposed internally of the heating chamber 10 through which saline (salt water) flows and is heated to form water vapor which enters first stage flash tank 12 at entry point 15.

Contact of the hot raw wet syngas with the heat transfer coil 21 results in transfer of heat to the saline present in the coil 21 and causes cooling of the wet syngas to form a condensate 23 which exits the bottom of the heating chamber 10 and is typically discharged. Cooled syngas exits the heating chamber at outlet port 19 and passes to the syngas clean-up station 36 where it is subjected to low temperature gas cleaning at about 75-115° F., more usually about 100° F. The syngas may be optionally further cooled with medium or low pressure steam generation or alternative cooling method at 25.

Saline from saline source 13 enters heat transfer coil 14 of flash tank chamber 28. Saline inside the coil 14 is heated by heat transfer as water vapor condenses against the heat transfer coil 14. Optionally, for distillation to occur at lower temperatures, either a vacuum pump or steam ejector 130, is connected to any or all of the flash tanks 12, 24, 26, or 28 lowering the internal tank pressure to be below atmospheric pressure. The pressure is successively reduced at each stage from flash tank 12 through to flash tank 28.

Fresh no-salt water condensate produced by this condensation process is collected in collector 18 and exits the tank at 42 as a stream of fresh no-salt water.

The incoming saline is heated further as it passes through the heat transfer coils 14 of flash tanks 28, 26, 24 and then 12. Heated saline exits distillation chamber 12 and enters the heat transfer coil 21. Raw wet hot syngas enters the heating chamber 10 syngas inlet 17 and contacts the heat transfer coil 21 to effect heat transfer to further heat saline passing internally through the heat transfer coil 21. Cooled syngas produced as a result of this heat transfer exits the heating chamber 10 through syngas outlet 19.

The cooled syngas may be optionally further cooled by passing through a steam generator 25 to produce medium or low pressure steam prior to undergoing syngas clean-up at clean-up station 36 where the syngas is subjected to low temperature gas cleaning. Clean syngas 40 resulting from this cleanup process is then exported to different fuel consumption host, and may be used for carbon conversion and hydrogen extraction.

Water vapor which condenses upon contact with coil 14 forms a no-salt fresh water condensate 16 which drips from the coil 14 into receptacle 18 of each flash tank and is collected at 42. Evaporation of the saline causes the brine 22 in the bottom of the distillation chamber to become increasingly salt-concentrated. Brine 22 passes to flash tanks 24,26,28, respectively, where the desalination process repeats at progressively lower pressures. Concentrated brine exits distillation chamber 28 and is typically discharged.

Referring again to the gasifier 8, coarse slag can form during the gasification process. Any such slag is solidified, collected and removed at the bottom of the gasifier vessel 8. Slag is a relatively rocky formation which is crushed by a slag crusher and then captured in lock hopper 38. The slag is removed when the lock hopper cycles, which occurs when the lock hopper is isolated from the gasifier vessel 8 followed by removal of the slag out of the lock hopper 38. The coarse slag drops onto the drag conveyor 41 for final disposal.

Fine slag is suspended in the quench water that collects at the bottom of the gasifier vessel 8. This is also known as black water and must be continuously blown down to lower pressure levels and minimize the concentration of fine slag contained within the quench water. The black water is discharged into settler tank 43 which allows the fines to settle out due to gravity and be removed from the bottom of the tank and discharged at 45. Cleaner water is drawn from the top of the settler tank at 47 and recycled to either a water treatment process 49 or to scrubber 34.

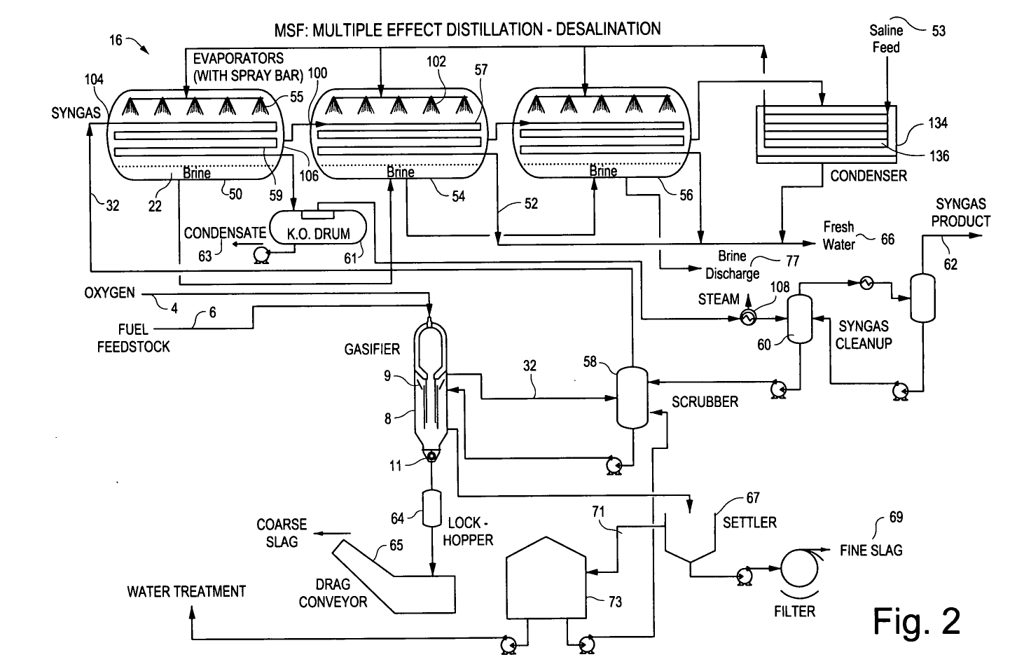

FIG. 2 illustrates a second embodiment of the process of the invention utilizing a multiple effect distillation desalination system 16, where like numerals designate like components. In this process, an oxidant (for example oxygen) 4 and a fuel feedstock 6 are injected into a gasifier 8, which produces a hot raw synthetic gas (syngas) 32 which is quenched with syngas scrubber discharge water, resulting in a wet raw syngas cooled to a temperature acceptable for entry into syngas pathway 59 within evaporator 50 though syngas inlet port 104.

Prior to entry into the evaporator 50, the raw wet syngas 32 is passed through the scrubber 58 to be scrubbed of impurities during which the syngas is cooled. Further cooling occurs within the pathway 59, which is typically a metallic heat transfer coil, as a result of heat transfer with saline from saline source 53 brought into contact with the exterior of the coil 59, typically by spraying salt water through spray bar 55. Cooled syngas passes from the coil 59 through syngas outlet port 106 into knock-out drum 61 where condensate 63 from the cooled wet raw syngas is collected and discharged. Cooled syngas is then passed from the knock-out drum 61 to syngas cleanup station 60 where it is subjected to low temperature gas cleaning at about 75-115° F., and optionally cooled with medium or low pressure steam generation or alternative cooling method at 108. The resulting clean syngas 62 is then exported to different fuel consumption host, and may be used for carbon conversion and hydrogen extraction. Optionally, for evaporation to occur at lower temperatures, the internal vessel pressure of any or all of the evaporators 50, 54 or 56 can be lowered to be below atmospheric pressure with a vacuum system.

The saline which is sprayed through spray bar 55 onto the exterior of the coil 59 of evaporator 50 undergoes evaporation to form water vapor due to heat transfer between the coil 59 heated by the hot syngas passing internally therethrough. The water vapor so produced passes from evaporator 50 into heat transfer coil 57 disposed internally of second evaporator 54 at vapor inlet port 100. Saline from salt water (saline) source 53 is sprayed onto the exterior of heat transfer coil 57 through spray bar 102, and the water vapor inside the coil 57 condenses within the heat transfer coil 57, exits second evaporator 54 along line 52 and is collected as no-salt fresh water condensate at 66. Water vapor produced by heat transfer in evaporator 54 passed into evaporator 56 where the process is repeated, and so on for as many evaporators as are present in the system. Water vapor exiting the last evaporator in the series 56 in FIG. 2) is condensed in condenser 134 by contact with heat transfer coil 136 through which cold saline feed is passed. No-salt fresh water condensate so produced is combined with that produced in the previous evaporators and collected at 66. Brine 22 collected at the bottom of first evaporator 50 is passed to the next succeeding evaporator(s) 54, 56, where the desalination process continues optionally at progressively lower pressure operating conditions, and later discharged.

As with the embodiment of FIG. 1, coarse slag can form during the gasification process. This slag is solidified, collected and removed at the bottom of the gasifier vessel 8. Slag is crushed by a slag crusher and then captured in lock hopper 64. The slag is removed when the lock hopper cycles, which occurs when the lock hopper is isolated from the gasifier vessel 8 followed by removal of the slag out of the lock hopper 64. The coarse slag drops onto the drag conveyor 65 for final removal.

As with the embodiment of FIG. 1, fine slag suspended within the quench water collects at the bottom of the gasifier vessel 8 (black water), and must be continuously blown down to lower pressure levels to minimize the concentration of fine slag contained within the quench water. The black water is discharged into settler tank 67 which allows the fines to settle out due to gravity and removed from the bottom of the tank and discharged at 69. Cleaner water is drawn from the top of the settler tank at 71 and passed to either a water treatment process 73, or the scrubber 34.

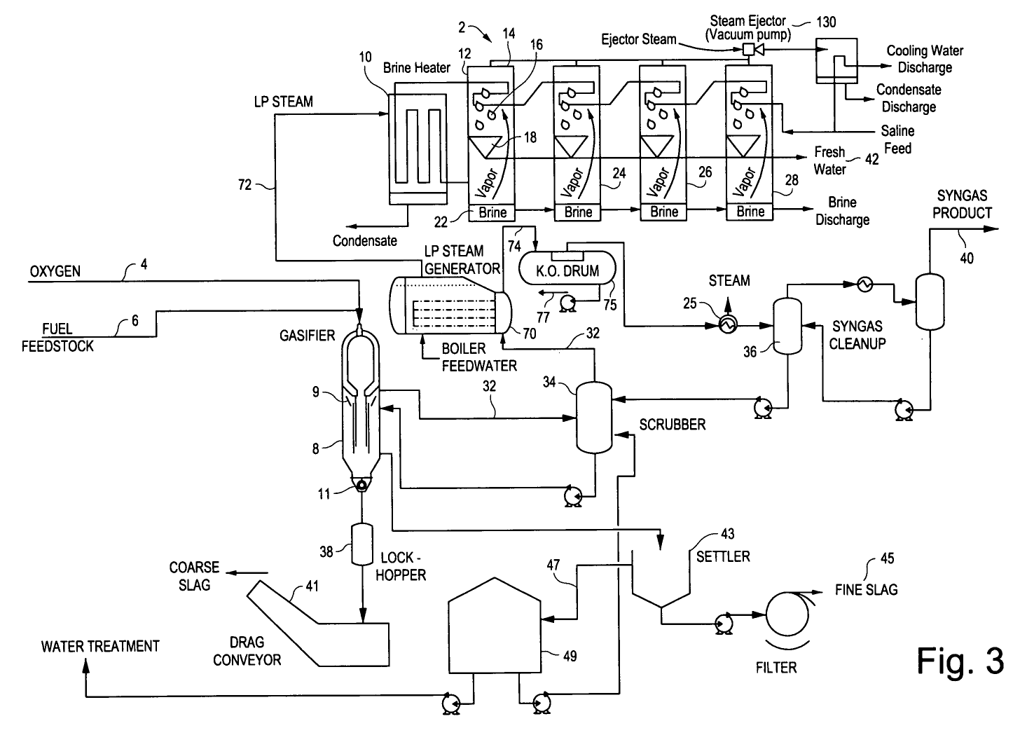

FIG. 3 is an alternative embodiment of FIG. 1 where like numerals designate like components. In this embodiment, the high temperature, raw, wet syngas 32 from scrubber 34 transfers heat to a low pressure saturated steam generator 70. Low pressure saturated steam generated in generator 70 is transferred through line 72 to heating chamber 10 where heat energy is transferred from the stream directly into the salt water present internally of the heat transfer coil 14. Steam condensate that forms in the heating chamber 10 is discharged through the bottom of the chamber 10.

Cooled raw syngas 74 from the steam generator 70 is passed into knock-out drum 75 where condensate is collected and discharged at 77. The cooled syngas then passes to clean-up station 36 where it is subjected to low temperature gas cleaning and, optionally, cooled with medium or low pressure steam generation or alternative cooling method at 25. Clean syngas 40 is then exported to different fuel consumption host, and may be used for carbon conversion and hydrogen extraction.

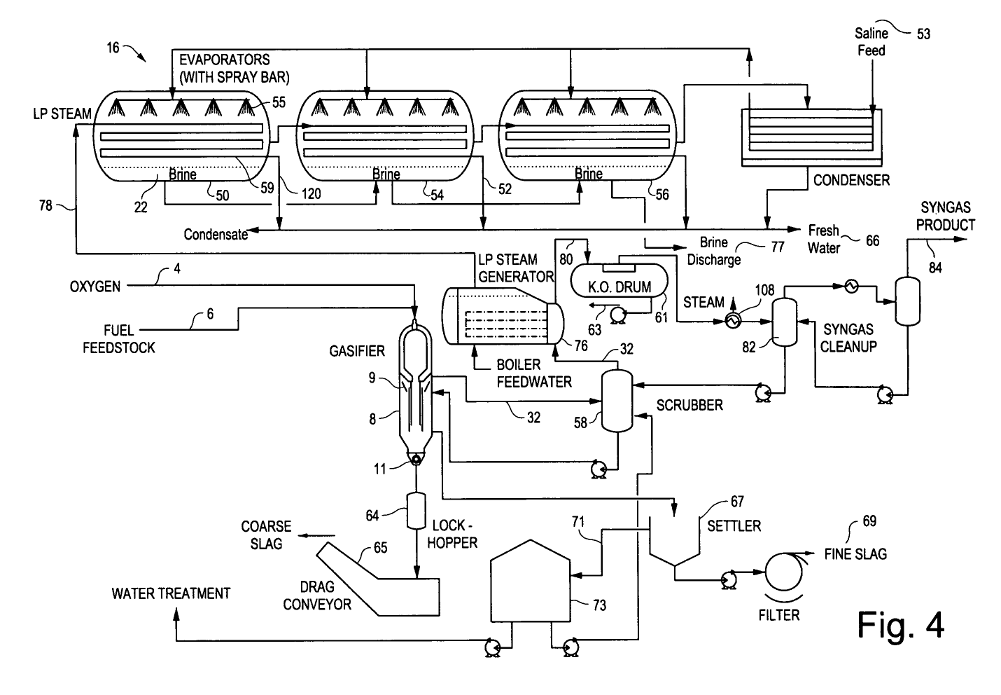

FIG. 4 is an alternative embodiment of FIG. 2 where like numerals designate like components. In this embodiment, the high temperature, raw, wet syngas 32 from scrubber 58 transfers heat to a low pressure saturated steam generator 76. Low pressure saturated steam generated in generator 76 passes to evaporator 50 through line 78 and heat from the steam is transferred directly to salt water sprayed onto the exterior of the coil 59. Steam condensate that forms inside the coil 59 is discharged at 120. Brine which collects in each of the evaporators 50, 54, 56 is collected at 77. Cooled raw syngas 80 from the steam generator 76 is passed into knock-out chamber 61 to clean-up station 82 where it is subjected to low temperature gas cleaning and optionally cooled with medium or low pressure steam generation or alternative cooling method at 108. The clean syngas 84 is then exported to different fuel consumption host, and may be used for carbon conversion and hydrogen extraction.

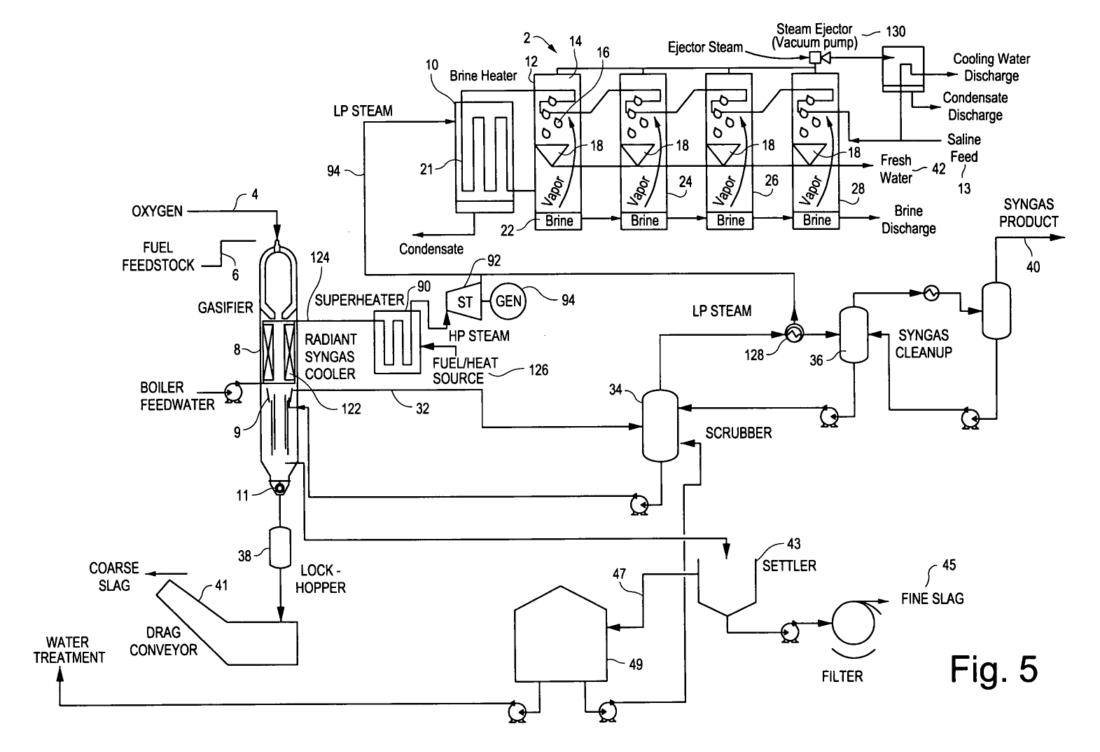

FIG. 5 is another embodiment of FIG. 1 where like numerals denote like components. In this embodiment, high temperature, raw, dry syngas 32 is cooled by passing initially through radiant syngas cooler 122 located in the gasifier 8, where heat transfer occurs to produce high pressure saturated steam and cooled wet raw syngas. The high pressure saturated steam is passed from the gasifier 8 through line 124 to auxiliary superheater 90 which is heated by an external heat source 126 to effect superheating of the steam. The superheated steam may then be used to drive auxiliary steam turbo machinery 92,94, during which the high pressure steam is converted to low pressure steam. This low pressure steam may then be introduced into the heating chamber 10 along line 94 together with low pressure steam produced at 128 from syngas exiting scrubber 34. Low pressure steam entering the heating chamber 10 transfers heat directly to the saline passing through the heat transfer coil 21. Steam condensate produced as a result of steam cooling due to contact with the heat transfer coil 21 collects in the bottom of the heating chamber 10 and is removed therefrom. The system otherwise operates as described above for FIG. 1.

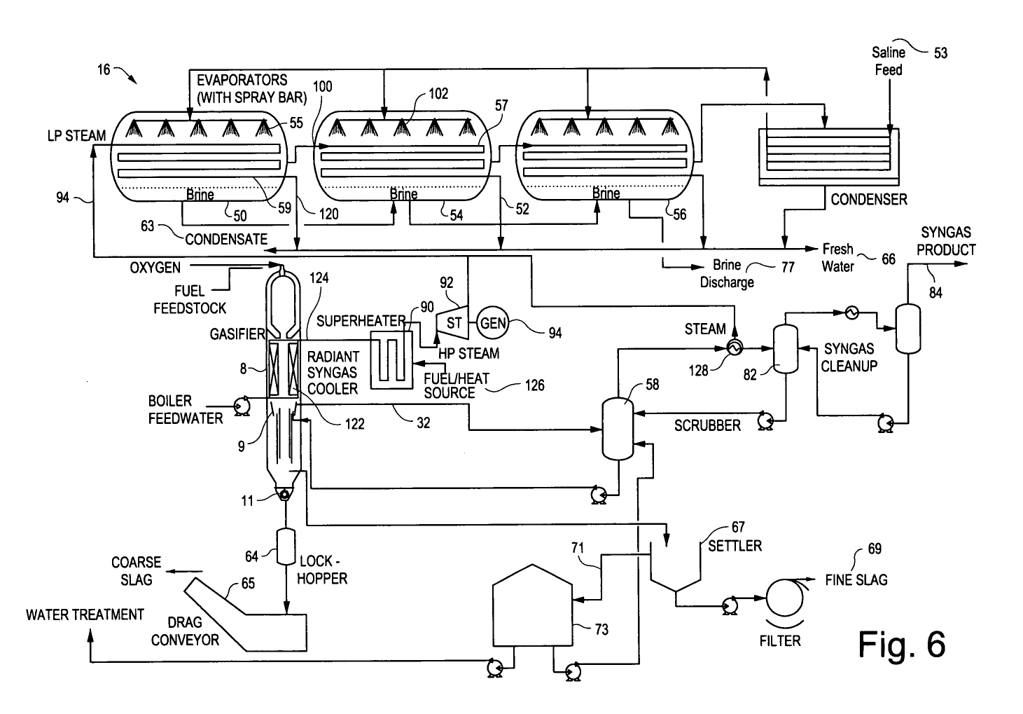

FIG. 6 is another embodiment of FIG. 2 where the high temperature, raw, dry syngas 32 is cooled by passing initially through radiant syngas cooler 122 located in the gasifier 8, where heat transfer occurs to produce high pressure saturated steam and cooled wet raw syngas. The high pressure saturated steam is passed from the gasifier 8 through line 124 to auxiliary superheater 90 which is heated by an external heat source 126 to effect superheating of the steam. The superheated steam may then be used to drive auxiliary steam turbo machinery 92,94, during which the high pressure steam is converted to low pressure steam. This low pressure steam may then be introduced into the evaporator 50 along line 94 together with low pressure steam produced at 128 from syngas exiting scrubber 58. Low pressure steam entering the heat transfer coil 59 in evaporator 50 transfers heat directly to the saline being sprayed onto the exterior of the coil 59 causing evaporation of the saline and condensation of the steam inside the coil 59 to produce a steam condensate. The steam condensate passes out of the evaporator 50 along line 120. The system otherwise operates as described above for FIG. 2.

According to the invention, MSF (multi-stage flash) or MED (multiple effect distillation) desalination and gasification processes are advantageously integrated with an elevated temperature, raw, wet synthetic gas (syngas) energy source to effect desalination of salt water. The invention is not limited, however, to MSF or MED desalination techniques, and can also be applied to other desalination processes that require salt water evaporation. The invention encompasses desalination employing gasification processes with other fuel feedstocks that are less prone to fouling and are low in ash composition (for example—residual fuel oil, tars and asphalts), thereby reducing operational costs. The raw syngas produced by these alternative gasification processes typically requires water quenching to achieve a syngas temperature within the operating limits of desalination and syngas clean-up equipment.

The invention also enjoys the advantage of providing an improvement of the overall thermal efficiency in generating fresh no-salt potable water from salt water desalination processes, utilizing reaction heat from a partial combustion process. The invention can directly use raw syngas or generate process steam with raw syngas as a means to deliver heat to a desalination process, and eliminates equipment associated with process steam extractions for desalination, such as conventional main steam boilers, main steam turbo machinery and/or other main steam cycle process equipment, thereby further reducing costs.

A yet further advantage is that by recovering heat from the gasification process and directly transferring the heat to a salt water source to evaporate the salt water, less capital equipment is required for process steam extraction and transmission systems which are currently employed in desalination processes. The syngas produced from the gasification process may then be used for other processes that require higher quality (i.e., low composition of impurities) fuel feedstocks such as power generation equipment. The invention therefore provides for an overall lower cost heat recovery equipment package for the purpose of salt water desalination when integrated with a gasification process.

A yet further advantage is that the invention has particular applicability for geographic locations (such as the Middle East, Saudi Arabia) known for water scarcity but with abundant supplies of waste fuel by-products. For existing desalination plants, low pressure steam is imported from the main steam cycle of either a low grade fuel oil fired boiler or a higher grade fuel gas or fuel oil fired gas turbine combined cycle plant.

As a non-limiting example of the process of the invention, a plant system model has demonstrated a potential plant configuration which integrates a gasification process, desalination module and gas turbine combined cycle power generation system. This particular model demonstrates, for example, that about 148 million BTU/hr may be recovered from the syngas and this is exchanged, along with heat from the combined cycle process, to salt water in the multi-stage flash desalination unit. According to this model, about 6 million gallons/day of freshwater may be produced.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for producing no-salt water by desalination of salt water, comprising evaporating salt water utilizing heat from synthetic gas produced in a gasification reaction, to produce no-salt water.

2. A process according to claim 1 wherein the heat is supplied directly to said salt water utilizing said synthetic gas.

3. A process according to claim 1 wherein the heat is supplied directly to said salt water utilizing a working fluid heated using synthetic gas.

4. A process according to claim 3 wherein the working fluid is steam.

5. A process according to claim 1 wherein the gasification reaction utilizes a fuel feedstock selected from the group consisting of residual fuel oil, tars and asphalts.

6. A process according to claim 1 wherein a multi-stage flash system is employed in conjunction with the desalination process.

7. A process according to claim 1 wherein a multi-effect distillation system is employed in conjunction with the desalination process.

8. A system for producing no-salt water by desalination of salt water, comprising:
a source of salt water;
a source of synthetic gas;
a heating chamber connected to the source of salt water and to the source of synthetic gas, the heating chamber having a synthetic gas inlet and a synthetic gas outlet and a pathway for the salt water to pass through the heating chamber;
at least one flash tank operable under reduced pressure connected to the pathway for receiving water vapor generated in the pathway; and
a collector for collecting condensate containing no or essentially no salt;
wherein when salt water from the salt water source is introduced into the pathway of the heating chamber and hot synthetic gas from the synthetic gas source is introduced into the synthetic gas inlet of the heating chamber, heat from the hot synthetic gas is transferred to the salt water to produce water vapor which is condensed in said at least one flash tank to produce no-salt water, which is collected in said collector.

9. A system according to claim 8, further comprising a synthetic gas clean-up system connected to said synthetic gas outlet of said heating chamber for receiving cooled synthetic gas exiting said heating chamber.

10. A system according to claim 8 wherein a series of flash tanks is provided for condensing water vapor, each flash tank operating at a progressively lower pressure downstream from said heating chamber.

11. A system for producing no-salt water by desalination of salt water, comprising:
a source of salt water;
a source of synthetic gas;
a source of steam;
a heating chamber connected to the source of salt water and to said source of steam, the heating chamber having a steam inlet, a steam condensate outlet and a pathway for salt water to pass through the heating chamber;
at least one flash tank operable under reduced pressure connected to the pathway for receiving water vapor generated in the pathway; and
a collector for collecting condensate produced by condensation of said water vapor and containing no or essentially no salt;
wherein when salt water from the salt water source is introduced into the pathway in the heating chamber and steam is introduced into the steam inlet of the heating chamber, heat from the steam is transferred to the salt water to produce water vapor which is condensed in said at least one flash tank to produce no-salt water, which is collected in said collector, and wherein steam condensate formed in said heating chamber is removed through said steam condensate outlet.

12. A system according to claim 11 further comprising a steam generator having a synthetic gas inlet and a synthetic gas outlet, wherein synthetic gas is fed into the steam generator through the synthetic gas inlet and steam is generated which is fed to said steam inlet in said heating chamber, whereby heat is transferred to salt water passing though the pathway disposed within the heating chamber to form water vapor which is condensed and collected as no-salt water.

13. A system according to claim 12 and further comprising a knock-out drum though which synthetic gas exiting the steam generator passes to allow moisture in the synthetic gas to condense and be separated from the synthetic gas prior to downstream clean-up of the synthetic gas.

14. A system for producing no-salt water by desalination of salt water, comprising:
a source of salt water;
a source of synthetic gas;
a first evaporation chamber having a synthetic gas inlet, a synthetic gas outlet, a salt water inlet, and a water vapor outlet, the synthetic gas inlet being connected to a pathway for synthetic gas to pass through the evaporation chamber and effect heat transfer to salt water introduced into the evaporation chamber through said salt water inlet to produce water vapor in the first evaporation chamber;
a second evaporation chamber having a salt water inlet, a water vapor inlet, and a second pathway connected to the water vapor outlet of the first evaporation chamber; and
a collector for collecting condensate produced by condensation of said water vapor and containing no or essentially no salt;
wherein synthetic gas from said synthetic gas source is introduced into said first pathway and salt water is introduced into said first evaporation chamber, such that heat from said synthetic gas is transferred to said salt water to produce water vapor which is introduced into said second pathway in said second evaporation chamber and condensed therein to produce no-salt water which is collected in said collector.

15. A system according to claim 14, and further comprising a steam generator having a synthetic gas inlet and a synthetic gas outlet, wherein synthetic gas is fed into the steam generator through the synthetic gas inlet and steam is generated which is fed to a steam inlet connected to said first pathway in said first evaporation chamber, whereby heat is transferred from the steam to salt water present in the evaporation chamber to form water vapor which is condensed in the second pathway of the second evaporation chamber and collected as no-salt water condensate.

16. A system according to claim 15, wherein the first evaporation chamber is provided with a steam condensate outlet through which steam condensate formed as a result of condensation of steam in the pathway of the first evaporation chamber is drained.

17. A system according to claim 15 and further comprising a knock-out drum through which synthetic gas exiting the steam generator passes to allow moisture in the synthetic gas to condense and be separated from the synthetic gas prior to downstream clean-up of the synthetic gas.

18. A system for producing no-salt water by desalination of salt water, comprising:
a source of salt water;
a source of synthetic gas comprising a radiant gas cooler;
a source of steam;
a heating chamber connected to the source of salt water and to the source of steam, the heating chamber having a steam inlet, a steam condensate outlet, a water vapor outlet and a pathway for the salt water to pass through the heating chamber;
at least one flash tank operable under reduced pressure connected to the pathway for receiving water vapor generated in the pathway;
an auxiliary superheater connected to auxiliary steam turbo machinery; and
a collector for collecting condensate containing no or essentially no salt;
hot synthetic gas produced in said synthetic gas source being cooled in said radiant gas cooler by heat transfer to produce high pressure steam and wet raw synthetic gas, said high pressure steam being superheated by said auxiliary superheater and driving said auxiliary steam turbo machinery;
whereby steam produced using said wet raw synthetic gas and obtained through use of said superheated high pressure steam is introduced into the heating chamber and heat is transferred to salt water in said pathway to produce water vapor in said pathway which water vapor is condensed in said at least one flash tank to produce no-salt water, which is collected in said collector.

19. A system for producing no-salt water by desalination of salt water, comprising:
a source of salt water;
a source of synthetic gas comprising a radiant gas cooler;
a first evaporation chamber having a steam inlet, a steam condensate outlet, a salt water inlet, and a water vapor outlet, the steam inlet being connected to a first pathway for steam to pass through the evaporation chamber and effect heat transfer to salt water introduced into the evaporation chamber through said salt water inlet to produce water vapor in the first evaporation chamber;
a second evaporation chamber having a salt water inlet, a water vapor inlet, and a second pathway connected to the water vapor outlet of the first evaporation chamber;
an auxiliary superheater connected to auxiliary steam turbo machinery; and
a collector for collecting condensate containing no or essentially no salt;
hot synthetic gas produced in said synthetic gas source being cooled in said radiant gas cooler by heat transfer to produce high pressure steam and wet raw synthetic gas, said high pressure steam being superheated by said auxiliary superheater and driving said auxiliary steam turbo machinery;
whereby steam produced using said wet raw synthetic gas and obtained through use of said superheated high pressure steam is introduced into the first pathway of the first evaporation chamber and heat is transferred to salt water in said first evaporation chamber to produce water vapor which is passed to the second pathway in said second evaporation chamber and condensed to produce no-salt water, which is collected in said collector.
